(19) United States
(12) Patent Application Publication
(10) Pub. No.: US 2010/0176047 A1
(43) Pub. Date: Jul. 15, 2010

(54) FLUID FILTER WITH NUTPLATE HAVING AN END FACE SEAL AND OUTER ATTACHMENT DESIGN

(75) Inventors: Ismail C. Bagci, Cookeville, TN (US); Terry W. Shults, Cookeville, TN (US)

Correspondence Address: HAMRE, SCHUMANN, MUELLER & LARSON, P.C., P.O. BOX 2902, MINNEAPOLIS, MN, 55402-0902, US

(73) Assignee: Cummins Filtration IP Inc., Minneapolis, MN (US)

(21) Appl. No.: 12/354,612

(22) Filed: Jan. 15, 2009

(51) Int. Cl. B01D 35/30

(52) U.S. Cl. 210/232

(57) ABSTRACT

A fluid filter has a filter element disposed inside a housing having a generally open end. The filter element has media allowing a working fluid to be filtered therethrough. A nutplate connected to the housing at the generally open end has an end face with an inlet and outlet. The inlet allows the working fluid to enter the generally open end of the housing and access the media. The outlet allows filtered fluid to exit the generally open end of the housing. The end face includes inner and outer seals. The inner seal surrounds one of the inlet or the outlet and is between them. The outer seal surrounds the other of the inlet and outlet. The inner seal separates non-filtered fluid from filtered fluid. The outer seal separates the fluid from the external environment. A connection structure on an outer surface of the nutplate allows connection to other equipment.

### FIELD

The present disclosure relates generally to fluid filters and their assemblies. More particularly, the present disclosure relates to an improved sealing and attachment configuration of a fluid filter.

### BACKGROUND

Fluid filters are widely known and used in various systems and applications, for example such systems that require particle and/or fluid separation from a working fluid. As one example, lube filtration systems are well known and employ oil filtration capabilities to separate various particulate and condensate matter. Proper sealing in such systems is important to maintain system efficiency in order to meet emission regulations and provide suitable protection to an engine. That is, proper sealing is needed to maintain separation between “dirty” and “clean” sides of fluid filter used in such systems.

Improvements can be made upon existing fluid filter designs. Particularly, structural improvements can be made as to how a fluid filter is sealed and connected to other equipment in a given filtration system.

### SUMMARY

The present disclosure generally relates to a fluid filter that includes a unique sealing and attachment configuration for the fluid filter to seal with and attach to other equipment, for example in a filtration system. The sealing and attachment configuration described herein can help make installation of the fluid filter easier by providing an in-line connection, and by providing an in-line seal that separates “dirty” fluid to be filtered from “clean” filtered fluid. Generally; the sealing configuration is on an end face of a filter nutplate and the attachment configuration resides on an external surface of the nutplate.

In one embodiment, a fluid filter includes a housing having a generally open end, and a filter element disposed inside the housing. The filter element has a media that allows a working fluid to be filtered through the filter media. A nutplate is connected to the housing at the generally open end. The nutplate has an end face including an inlet and an outlet. The inlet allows working fluid to be filtered to enter the generally open end of the housing and flow to the media. The outlet allows working fluid filtered by the media to exit the generally open end of the housing. The end face also includes inner and outer seals disposed thereon. The inner seal surrounds the one of the inlet or the outlet and is between the inlet and the outlet. The outer seal surrounds the other of the inlet or the outlet. In operation, the inner seal separates the working fluid to be filtered from the working fluid filtered by the media, and the outer seal separates the working fluid from the external environment. The nutplate further includes a connection structure on an external surface thereof. The connection structure is connectable to other equipment.

In some embodiments, the fluid filter is a spin-on filter, where the inner and outer end face seals create an inline seal with other equipment that the fluid filter may be attached, and where the connection structure on the external surface is a threaded portion that can mate with such other equipment.

### BRIEF DESCRIPTION OF THE DRAWINGS

FIG. 1 is a top perspective view of an embodiment of a filter.

FIG. 2 is a side sectional view of the filter of FIG. 1.

FIG. 3 is a top perspective view of another embodiment of a filter.

FIG. 4 is side sectional view of the filter of FIG. 3.

FIG. 5 is a top perspective view of another embodiment of a filter.

FIG. 6 is a side sectional view of the filter of FIG. 5.

### DETAILED DESCRIPTION

The present disclosure generally relates to a fluid filter that includes a unique sealing and attachment configuration for the fluid filter to seal with and attach to other equipment, for example in a filtration system. The sealing and attachment configuration described herein can help make installation of the fluid filter easier by providing an in-line connection, and by providing an in-line seal that separates “dirty” fluid to be filtered from “clean” filtered fluid. Generally, the sealing configuration is on an end face of a filter nutplate and the attachment configuration resides on an external surface of the nutplate.

The designs described herein generally incorporate external buttress or similar connections, which have shown to be more robust than the internal fine threads used on many current designs. This can be especially true with regard to composite constructions, and would result in a design that gives better structural integrity to the filter.

For illustration purposes only, the inventive concepts for a filter design are described with respect to spin-on type fluid filters, which are well known and are often used in lube filtration systems. It will be appreciated, however, that the disclosure is not meant to be limiting to spin-on type filters, and that the inventive concepts described herein, including the sealing and attachment interfaces, can be used in and adapted for other filtration systems such as but not limited to filtration systems for fuel, hydraulics, water, etc. It therefore will be further appreciated that various working fluids in need of filtration, including but not limited to oil, can benefit from the inventive concepts disclosed herein.

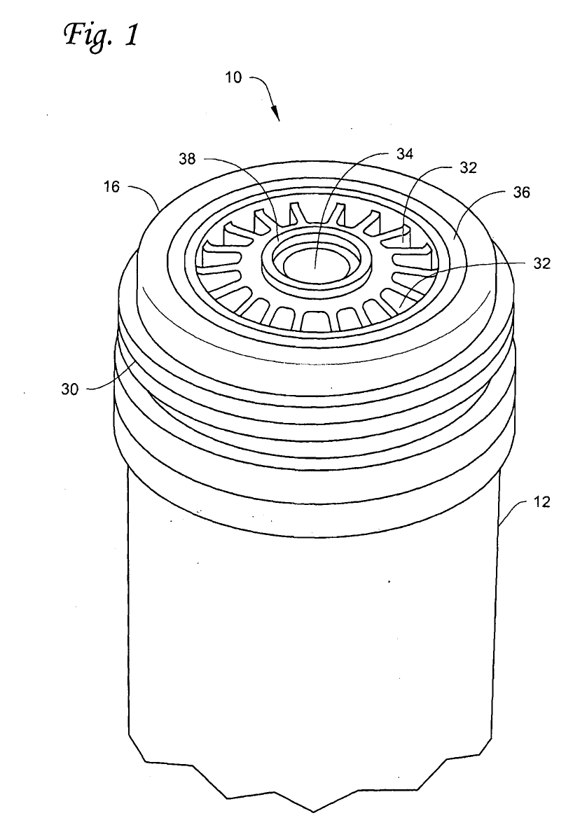

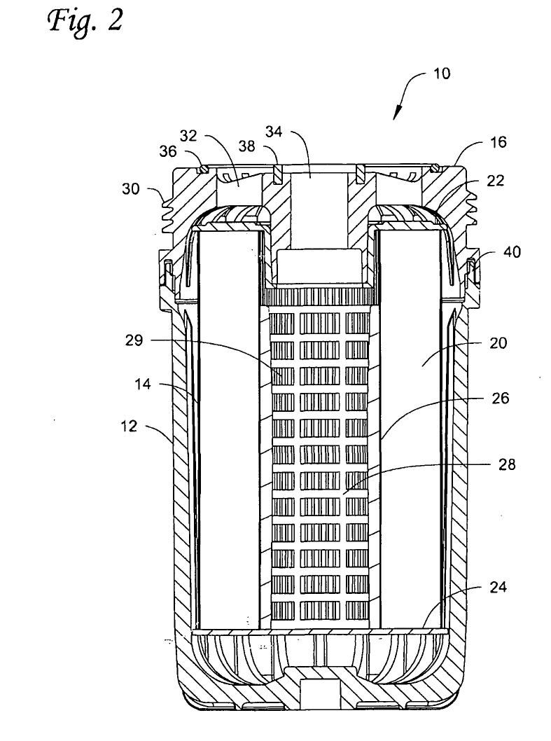

FIGS. 1-2 show a fluid filter 10 in accordance with inventive principles described herein. The fluid filter 10 generally includes a housing 12, a filter element 14, and a nutplate 16. The housing 10 has a generally open end (see e.g. FIG. 2). The filter element 14 is disposed inside the housing 12. The filter element 14 has a media 20 that allows a working fluid to be filtered therethrough.

The nutplate 16 is connected to the housing 12 at the generally open end. As one preferred example, the nutplate 16 is connected to the housing 12 through a spin-weld process. Such connection is easily achieved, for example, in fluid filters with composite housings and nutplates. In one preferred example, the fluid filter 10 is a composite material that does not include metal parts, and particularly where the nutplate 16 and the housing 12 are constructed of composite materials. Examples of composite filters can be found in previous products of the Assignee, Cummins Filtration, such as its User-Friendly Filter, which is well known.

The nutplate 16 has an end face (see top of nutplate 16 in FIGS. 1 and 2) including an inlet 32 and an outlet 34. Generally, the inlet 32 allows working fluid to be filtered to enter the generally open end of the housing 12 and flow to the media 20. As shown, the inlet 32 can be for example many openings in the end face of the nutplate 16. It will be appreciated that the amount of openings for the inlet 32 is not meant to be limiting, as long as the working fluid can enter (or exit) the fluid filter 10. The outlet 34 generally allows working fluid filtered by the media 20 to exit the generally open end of the housing 12. As shown the outlet 34 is disposed toward the center of the end face of the nutplate 16, and the inlet 32 is disposed around the outlet 34 in a concentric arrangement. It will be appreciated that the specific inlet 32/outlet 34 arrangement is not meant to be limiting and that other modifications may be equally suitable and/or desired. For example, the inlet and outlet may be switched if desired and/or necessary, where the flow of fluid is reversed.

With further reference to the end face of the nutplate 16, the end face includes inner and outer seals 38, 36 disposed thereon. As shown, the inner seal 38 surrounds the outlet 34 and is between the inlet 32 and the outlet 34. The outer seal 36 surrounds the inlet 32. In operation, the inner seal 38 separates the working fluid to be filtered from the working fluid filtered by the media 20, and the outer seal 36 separates the working fluid from the external environment.

As shown, the inner and outer seals 38, 36 are disposed within grooves on the end face of the nutplate 16 (best shown in FIG. 2). In one example, the end face of the nutplate 16 is configured such that the inner and outer seals 38, 36 are disposed in a planar arrangement on the end face. In FIGS. 1 and 2, the inner and outer seals 38, 36 reside on a same plane. For example, the seal configuration of seals 38, 36 allows for a relatively simple, flat planar seal, which can reduce the amount of machining (e.g. for metal), forming (e.g. for composite), etc.

In one embodiment, the inner and outer seals 38, 36 are concentrically arranged, where the inlet 32 and outlet 34 and respective seals 38, 36 occupy a majority of the end face of the nutplate 16. Such a configuration can provide a face-like seal and face-like fluid flow for the fluid filter 10 and the filtration system that it may be connected to.

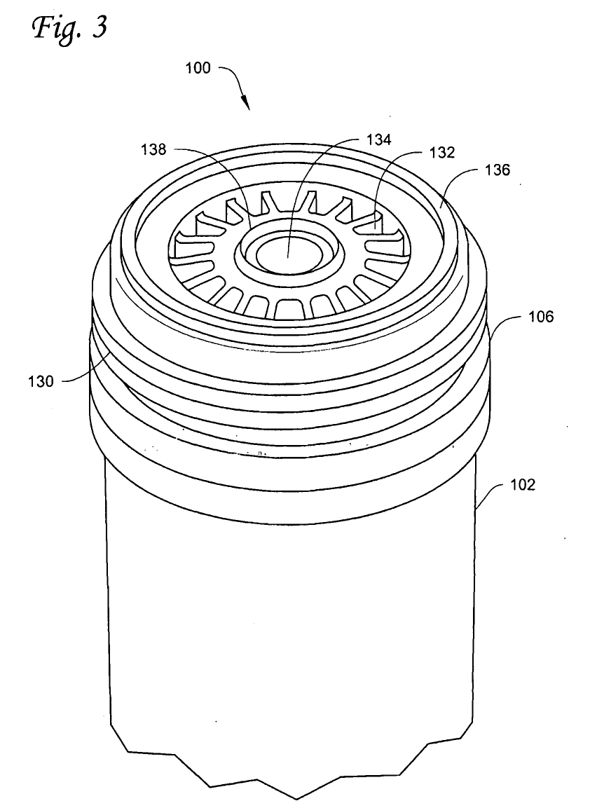

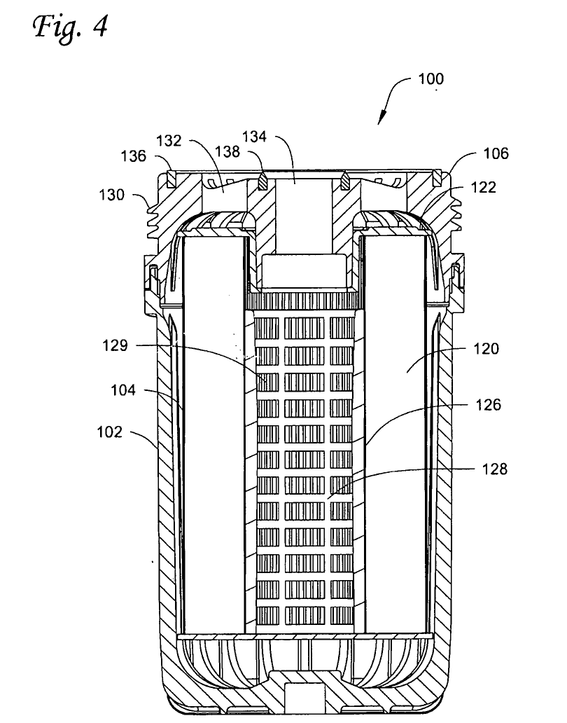

In the embodiment of FIGS. 1 and 2, the inner seal 38 is shown as a rectangular gasket seal. It will be appreciated that the inner seal 38 is not limited to a rectangular gasket seal. Other configurations may include but are not limited to an o-ring or a crush-rib seal (see e.g. FIGS. 3 and 4 described below). For example, a crush-rib seal may be employed for larger micron rated filters. It further will be appreciated that such materials for the inner seal 38 are well known and need not be further described.

In one embodiment, the outer seal 36 is shown as an o-ring. It will be appreciated that the outer seal 36 is not limited to an o-ring seal. Other configurations may include but are not limited to a rectangular gasket seal (see e.g. FIGS. 3 and 4 further described below). It is appreciated that such materials for the outer seal 36 are well known and need not be further described. Depending upon the fluid requirements, the material used for the seals, for example can be a nitrile or synthetic rubber material such as Viton®.

The nutplate 16 also includes a connection structure 30 disposed on an external surface thereof. Generally, the connection structure 30 is connectable to other equipment, for example, another component of a filtration system. In one embodiment, the connection structure 30 is a threaded portion on an external side surface of the nutplate 16. In a composite fluid filter, for example, the connection structure 30 can be molded onto the external surface of the nutplate 16. In the example where a thread is used, the threads can be molded onto the outside of the nutplate 16 (e.g. for composite material). It will be appreciated that the connection portion 30 can be structures other than a threaded portion. For example, the connection portion 30 may be any suitable mechanical structure that may be known and can be employed to connect the external surface of the nutplate to other equipment. As other examples, quarter-turn or half-turn connections may be employed as the connection structure 30, such as one of skill in the art could accomplish, and which may or may not include threads.

In one embodiment, the external side surface that the connection structure 30 is on a surface other than the end face. In the example shown, the external side surface is perpendicular to the end face.

The connection structure 30 configuration can allow the fluid filter 10 to be connected to other equipment of a filtration system and in an in-line arrangement. The nutplate 16 design can be compatible with filter housings or shells of varying lengths. Further, such a design incorporates external buttress or similar connections, which have shown to be more robust than the internal fine threads used on many current designs. This can be especially true with regard to composite constructions, and would result in a design that gives better structural integrity to the filter. Even further, using external threads outside of the sealing region for example can reduce possible contaminate entering the filter during the installation process. This can reduce any particles, machine operation debris, composite material flash, during threading (e.g. installation) of the filter.

In FIGS. 1 and 2, the nutplate 16 is shown connected to the filter element 14 and retains the filter element 14 inside the housing 12.

With further reference to the filter element 14, one embodiment of a filter element/that has been used is where the media 20 is attached to two endplates 22, 24. One endplate 22 includes an opening in fluid communication with the outlet 34. A center tube 26 is connected between the two endplates 22, 24. The media 20 is disposed around the center tube 26 in a cylindrical arrangement. The center tube 26 includes a flow passage 28 therethrough that is in fluid communication with the opening of the one endplate 22. The center tube further includes apertures 29 that allow the working fluid to flow from the media 20 and through the flow passage 28 of the center tube 26. It will be appreciated that the particular filter element arrangement and structure is not meant to be limiting. As long as fluid flow and filtration capability can be achieved, other filter elements may have different constructions that are compatible with the inlet/outlet and seal structure of the nutplate 16 and with the housing 12.

FIGS. 3-4 show another embodiment of a fluid filter 100. As with fluid filter 10, the fluid filter 100 generally includes a housing 102, a filter element 104, and a nutplate 106. The housing 100 has a generally open end (see e.g. FIG. 4). The filter element 104 is disposed inside the housing 102. The filter element 104 has a media 120 that allows a working fluid to be filtered therethrough. Fluid filter 100 includes many similar features as fluid filter 10, but with some differences in the type of seals used.

The nutplate 106 is connected to the housing 102 at the generally open end. As one preferred example, the nutplate 106 is connected to the housing 102 through a spin-weld process. Such connection is easily achieved, for example, in fluid filters with composite housings and nutplates. In one preferred example, the fluid filter 100 also is a composite material that does not include metal parts, and particularly where the nutplate 106 and the housing 102 are constructed of composite materials. Examples of composite filters can be found in previous products of the Assignee, Cummins Filtration, such as its User-Friendly Filter, which is well known.

The nutplate 106 has an end face (see top of nutplate 106 in FIGS. 3 and 4) including an inlet 132 and an outlet 134. Generally, the inlet 132 allows working fluid to be filtered to enter the generally open end of the housing 102 and flow to the media 120. As shown, the inlet 132 can be for example many openings in the end face of the nutplate 106. It will be appreciated that the amount of openings for the inlet 132 is not meant to be limiting, as long as the working fluid can enter (or exit) the fluid filter 100. The outlet 134 generally allows working fluid filtered by the media 120 to exit the generally open end of the housing 102. As shown the outlet 134 is disposed toward the center of the end face of the nutplate 106, and the inlet 132 is disposed around the outlet 34 in a concentric arrangement. As with fluid filter 10, it will be appreciated that the specific inlet 132/outlet 134 arrangement is not meant to be limiting and that other modifications may be equally suitable and/or desired. For example, the inlet and outlet may be switched if desired and/or necessary, where the flow of fluid is reversed.

With further reference to the end face of the nutplate 106, the end face includes inner and outer seals 138, 136 disposed thereon. As shown, the inner seal 138 surrounds the outlet 134 and is between the inlet 132 and the outlet 134. The outer seal 136 surrounds the inlet 132. In operation, the inner seal 138 separates the working fluid to be filtered from the working fluid filtered by the media 120, and the outer seal 136 separates the working fluid from the external environment.

As shown, the inner and outer seals 138, 136 are disposed within grooves on the end face of the nutplate 106 (best shown in FIG. 4). In one example, the end face of the nutplate 106 is configured such that the inner and outer seals 138, 136 are disposed in a planar arrangement on the end face. In FIGS. 3 and 4, the inner and outer seals 138, 136 reside on a same plane. For example, the seal configuration of seals 138, 136 allows for a relatively simple, flat planar seal, which can reduce the amount of machining (e.g. for metal), forming (e.g. for composite), etc.

In one embodiment, the inner and outer seals 138, 136 are concentrically arranged, where the inlet 132 and outlet 134 and respective seals 138, 136 occupy a majority of the end face of the nutplate 106. Such a configuration can provide a face-like seal and face-like fluid flow for the fluid filter 100 and the filtration system that it may be connected to.

In the embodiment of FIGS. 3 and 4, the inner seal 138 is shown as a crush rib seal. It will be appreciated that the inner seal 138 is not limited to a crush rib seal. For example, a crush-rib seal may be employed for larger micron rated filters. Other configurations may include but are not limited to an o-ring or a rectangular gasket. It further will be appreciated that such materials for the inner seal 138 are well known and need not be further described.

In one embodiment, the outer seal 136 is shown as a rectangular gasket seal. It will be appreciated that the outer seal 136 is not limited to a rectangular gasket. Other configurations may include but are not limited to an o-ring seal. It is appreciated that such materials for the outer seal 136 are well known and need not be further described.

The nutplate 106 also includes a connection structure 130 disposed on an external surface thereof. Generally, the connection structure 130 is connectable to other equipment, for example, another component of a filtration system. In one embodiment, the connection structure 130 is a threaded portion on an external side surface of the nutplate 106. In a composite fluid filter, for example, the connection structure 130 can be molded onto the external surface of the nutplate 106. In the example where a thread is used, the threads can be molded onto the outside of the nutplate 106 (e.g. for composite material). It will be appreciated that the connection portion 130 can be structures other than a threaded portion. For example, the connection portion 130 may be a quarter turn lock or any suitable mechanical structure that may be known and can be employed to connect the external surface of the nutplate to other equipment.

In one embodiment, the external side surface that the connection structure 130 is on is a surface other than the end face. As shown, the external side surface is perpendicular to the end face.

The connection structure 130 configuration can allow the fluid filter 100 to be connected to other equipment of a filtration system and in an in-line arrangement: The nutplate 106 design can be compatible with filter housings or shells of varying lengths.

In FIGS. 3 and 4, the nutplate 106 is shown connected to the filter element 104 and retains the filter element 104 inside the housing 102.

With further reference to the filter element 104, one embodiment of a filter element that has been used is where the media 120 is attached to two endplates. One endplate 122 includes an opening in fluid communication with the outlet 134. A center tube 126 is connected between the endplates. In one example, the center tube can be a part of the endplate 122. The media 120 is disposed around the center tube 126 in a cylindrical arrangement. The center tube 126 includes a flow passage 128 therethrough that is in fluid communication with the opening of the endplate 122. The center tube 126 further includes apertures 129 that allow the working fluid to flow from the media 120 and through the flow passage 128 of the center tube 126. It will be appreciated that the particular filter element arrangement and structure is not meant to be limiting. As long as fluid flow and filtration capability can be achieved, other filter elements may have different constructions that are compatible with the nutplate 106 and housing 102.

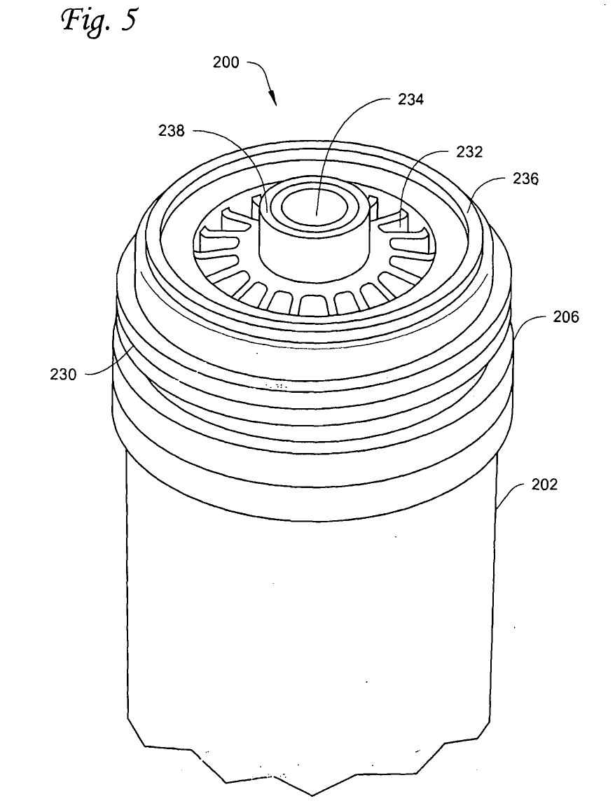

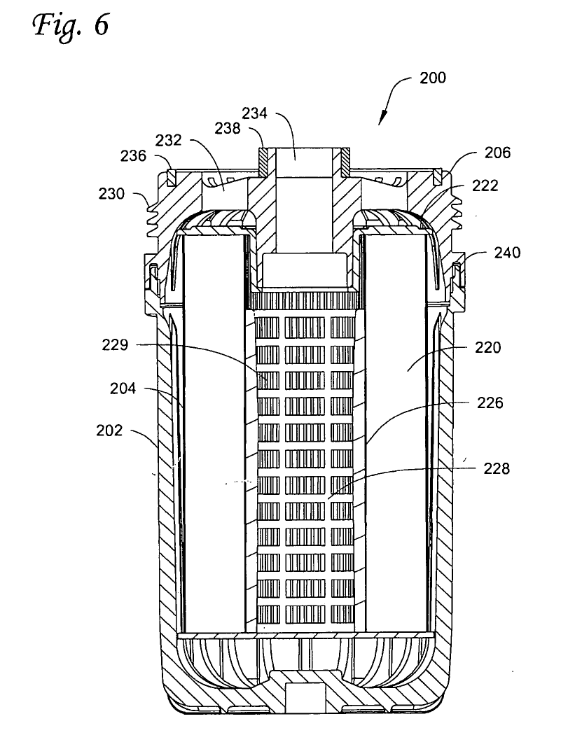

With reference to FIGS. 5-6, a fluid filter 200 is shown. As with fluid filters 10, 100, the fluid filter 200 generally includes a housing 202, a filter element 204, and a nutplate 206. The housing 200 has a generally open end (see e.g. FIG. 4). The filter element 204 is disposed inside the housing 202. The filter element 204 has a media 220 that allows a working fluid to be filtered therethrough. Fluid filter 200 includes many similar features as fluid filters 10, 100, but with some differences which are described below.

The nutplate 206 is connected to the housing 202 at the generally open end. As one preferred example, the nutplate 206 is connected to the housing 202 through a spin-weld process. Such connection is easily achieved, for example, in fluid filters with composite housings and nutplates. In one preferred example, the fluid filter 200 also is a composite material that does not include metal parts, and particularly where the nutplate 206 and the housing 202 are constructed of composite materials. Examples of composite filters can be found in previous products of the Assignee, Cummins Filtration, such as its User-Friendly Filter, which is well known.

The nutplate 206 has an end face (see top of nutplate 206 in FIGS. 5 and 6) including an inlet 232 and an outlet 234. Generally, the inlet 232 allows working fluid to be filtered to enter the generally open end of the housing 202 and flow to the media 220. As shown, the inlet 232 can be for example many openings in the end face of the nutplate 206. It will be appreciated that the amount of openings for the inlet 232 is not meant to be limiting, as long as the working fluid can enter (or exit) the fluid filter 200. The outlet 234 generally allows working fluid filtered by the media 220 to exit the generally open end of the housing 202. As shown the outlet 234 is disposed toward the center of the end face of the nutplate 206, and the inlet 232 is disposed around the outlet 234 in a concentric arrangement. It will be appreciated that the specific inlet 232/outlet 234 arrangement is not meant to be limiting and that other modifications may be equally suitable and/or desired. As with fluid filters 10, 100 above, for example, the inlet 232 and outlet 234 of fluid filter 200 may be switched if desired and/or necessary, where the flow of fluid is reversed.

With further reference to the end face of the nutplate 206, the end face includes inner and outer seals 238, 236 disposed thereon. As shown, the inner seal 238 surrounds the outlet 232 and is between the inlet 232 and the outlet 234. The outer seal 236 surrounds the inlet 234. In operation, the inner seal 238 separates the working fluid to be filtered from the working fluid filtered by the media 220, and the outer seal 236 separates the working fluid from the external environment.

In one example, the end face of the nutplate 206 is configured such that the inner and outer seals 238, 236 are disposed on the end face. As shown, the outer seal 236 is disposed within a groove on the end face of the nutplate 206, and the inner seal 238 is disposed about a protruding spud of the outlet 234. In FIGS. 5 and 6, the inner and outer seals 238, 236 reside in a slightly offset manner, but remain on the end face of the nutplate 206.

In one embodiment, the inner and outer seals 238, 236 are concentrically arranged, where the inlet 232 and outlet 234 and respective seals 238, 236 occupy a majority of the end face of the nutplate 206. Such a configuration can provide a face-like seal and face-like fluid flow for the fluid filter 200 and the filtration system that it may be connected to.

In the embodiment of FIGS. 5 and 6, both the inner and outer seals 238, 236 are shown as rectangular gasket seals. As described above, it generally will be appreciated that the inner and outer seals are not limited to the specific seals shown. Other types of seals and materials may be employed as long as the face-like seal on the end of the nutplate can be achieved. It further will be appreciated that such materials for the inner and outer seals 238, 236 are well known and need not be further described.

The nutplate 206 also includes a connection structure 230 disposed on an external surface thereof. Generally, the connection structure 230 is connectable to other equipment, for example, another component of a filtration system. In one embodiment, the connection structure 230 is a threaded portion on an external side surface of the nutplate 206. In a composite fluid filter, for example, the connection structure 230 can be molded onto the external surface of the nutplate 206. In the example where a thread is used, the threads can be molded onto the outside of the nutplate 206 (e.g. for composite material). It will be appreciated that the connection portion 230 can be structures other than a threaded portion. For example, the connection portion 230 may be a quarter turn lock or any suitable mechanical structure that may be known and can be employed to connect the external surface of the nutplate to other equipment.

In one embodiment, the external side surface that the connection structure 230 is on is a surface other than the end face. As shown, the external side surface is perpendicular to the end face.

The connection structure 230 configuration can allow the fluid filter 200 to be connected to other equipment of a filtration system and in an in-line arrangement. The nutplate 206 design can be compatible with filter housings or shells of varying lengths.

In FIGS. 5 and 6, the nutplate 206 is shown connected to the filter element 204 and retains the filter element 204 inside the housing 202.

With further reference to the filter element 204, one embodiment of a filter element that has been used is where the media 220 is attached to two endplates. One endplate 222 includes an opening in fluid communication with the outlet 234. A center tube 226 is connected between the endplates and, similar to fluid filter 100, the center tube 226 can be a part of the endplate 222. The media 220 is disposed around the center tube 226 in a cylindrical arrangement. The center tube 226 includes a flow passage 228 therethrough that is in fluid communication with the opening of the endplate 222. The center tube 226 further includes apertures 229 that allow the working fluid to flow from the media 220 and through the flow passage 228 of the center tube 226. It will be appreciated that the particular filter element arrangement and structure is not meant to be limiting. As long as fluid flow and filtration capability can be achieved, other filter elements may have different constructions that are compatible with the nutplate 206 and housing 202.

While the above is a complete description of the preferred embodiments of the invention, various alternatives, modifications, and equivalents may be used. Therefore, the above description should not be taken as limiting the scope of the invention which is defined by the appended claims.

What is claimed is:

1. A fluid filter comprising:
a housing having a generally open end;
a filter element disposed inside the housing, the filter element having a media that allows a working fluid to be filtered through the filter media; and
a nutplate connected to the housing at the generally open end, the nutplate having an end face including an inlet and an outlet, the inlet allows working fluid to be filtered to enter the generally open end of the housing and flow to the media, and the outlet allows working fluid filtered by the media to exit the generally open end of the housing,
the end face including inner and outer seals disposed thereon, the inner seal surrounds one of the inlet or the outlet and is between the inlet and the outlet, and the outer seal surrounds the other of the inlet or the outlet, the inner seal in operation separates the working fluid to be filtered from the working fluid filtered by the media, and the outer seal in operation separates the working fluid from the external environment, and
the nutplate including a connection structure disposed on an external surface thereof, the connection structure is connectable to other equipment.

2. The fluid filter of claim 1, wherein the fluid filter is a spin-on filter.

3. The fluid filter of claim 1, wherein the housing and nutplate are connected through a spin-weld connection.

4. The fluid filter of claim 1, wherein the inner and outer seals are disposed within grooves on the end face of the nutplate.

5. The fluid filter of claim 1, wherein the end face is configured such that the inner and outer seals are disposed in a planar arrangement on the end face, the inner and outer seals residing on a same plane.

6. The fluid filter of claim 1, wherein the inner and outer seals are concentrically arranged.

7. The fluid filter of claim 1, wherein the inner seal is one of a rectangular gasket, an o-ring, or a crush-rib seal.

8. The fluid filter of claim 1, wherein the outer seal is one of a rectangular gasket or an o-ring.

9. The fluid filter of claim 1, wherein the connection structure is a threaded portion on an external side surface of the nutplate, the external side surface being a surface other than the end face.

10. The fluid filter of claim 9, wherein the external side surface is perpendicular to the end face.

11. The fluid filter of claim 1, wherein the nutplate is connected to the filter element and retains the filter element inside the housing.

12. The fluid filter of claim 1, wherein the media is attached to two endplates, one endplate includes an opening in fluid communication with the outlet, and a center tube connected between the two endplates, the media is disposed around the center tube in a cylindrical arrangement, the center tube includes a flow passage therethrough that is in fluid communication with the opening of the one endplate, and the center tube includes apertures that allow the working fluid to flow from the media and through the flow passage of the center tube.

13. The fluid filter of claim 1, wherein the nutplate is a composite material.
